(19) United States
(12) Patent Application Publication
(10) Pub. No.: US 2011/0079251 A1
(43) Pub. Date: Apr. 7, 2011

(54) METHOD FOR IN-SITU CLEANING OF DEPOSITION SYSTEMS

(76) Inventors: Olga Kryliouk, Sunnyvale, CA (US); Jie Su, Santa Clara, CA (US); Kevin Griffin, Livermore, CA (US); Sandeep Nijhawan, Los Altos, CA (US)

(21) Appl. No.: 12/749,087

(22) Filed: Mar. 29, 2010

Related U.S. Application Data
(60) Provisional application No. 61/173,418, filed on Apr. 28, 2009.

(51) Int. Cl. B08B 5/00

(52) U.S. Cl. 134/31

(57) ABSTRACT

A method for in-situ cleaning of a deposition system is disclosed. The method includes providing a deposition system with portions of the deposition system deposited with at least a group III element or a compound of a group III element. Halogen containing fluid is introduced into the deposition system. The halogen containing fluid is permitted to react with the group III element to form a halide. The halide in solid state is converted to a gaseous state. The halide in gaseous state is purged out of the deposition system.

### CROSS REFERENCE TO RELATED APPLICATIONS

This application claims the benefit and priority of U.S. Provisional Application Ser. No. 61/173,418, filed Apr. 28, 2009, which is incorporated herein by reference in its entirety for all purposes.

### BACKGROUND

1. Technical Field

The present disclosure relates to in-situ cleaning of deposition system and more specifically in-situ cleaning of showerhead, susceptor and other internal parts of a MOCVD deposition system.

2. Related Art

Group III-V semiconductors are increasingly being used in light-emitting diodes (LEDs) and laser diodes (LDs). Specific Group III-V semiconductors, such as gallium nitride (GaN), are emerging as important materials for the production of shorter wavelength LEDs and LDs, including blue and ultra-violet emitting optical and optoelectronic devices. Thus, there is increasing interest in the development of fabrication processes to make low-cost, high-quality Group III-V semiconductor films.

In some applications, metal-organic chemical vapor deposition (MOCVD) is used to form Group III-V nitride films. MOCVD uses a reasonably volatile metalorganic Group III precursor such as trimethylgallium (TMGa) or trimethylaluminum (TMAl) to deliver the Group III metal to the substrate where it reacts with the nitrogen based precursor (e.g., ammonia, NH3) to form the Group III-V nitride film.

During the MOCVD film depositions with trimethylgallium, gallium is formed as a final product as part of the decomposition of trimethylgallium. In addition, with nitrogen based precursor, GaN particles are released. The GaN particles react with hydrogen, to form Ga in gaseous form and ammonia. The gaseous Ga is converted to liquid Ga and gets deposited as parasitic deposition on internal parts of the deposition system. For example, liquid Ga may be deposited on the showerhead, susceptor, liner and carrier of the deposition system.

The parasitic deposition of Ga on the internal parts of the deposition system may cause particles and flakes inside the deposition chamber. In addition, parasitic deposition of Ga may cause drift in the growth conditions of the thin film being deposited. The parasitic deposition of Ga may also affect process reproducibility and uniformity in the thin film being deposited. Finally, the parasitic deposition may necessitate periodic chamber cleaning and thereby reducing the reactor efficiency, due to down time attributable to the periodic chamber cleaning. Chamber cleaning typically involves shutting down the system, taking apart the parts, for example, the showerhead, cleaning the parts using a cleaning agent and reassembling the parts.

There is a need to come up with a more efficient cleaning process so as to increase the efficiency of the deposition system. There is also a need to reduce the down time of the system so as to increase throughput of the system. There is also a need to improve the process reproducibility and uniformity in the thin film being deposited. It is with these needs in mind, the current disclosure arises.

### SUMMARY

The concepts and methods of this disclosure allow for in-situ cleaning of one or more of internal parts of a CVD deposition system. For example, the showerhead, susceptor, liner and carriers of a MOCVD deposition system may be cleaned.

In one aspect, a method for in-situ cleaning of a deposition system is disclosed. A deposition system with a portion of the deposition system deposited with at least a group III element or a compound of a group III element is provided. A halogen containing fluid is introduced into the deposition system. The halogen containing fluid is permitted to react with the group III element or the compound of the group III element to form a halide. Then, the halide is converted to a gaseous state. The halide in gaseous state is purged out of the deposition system.

In one embodiment, the portion of the deposition system deposited with the group III element is a showerhead of the deposition system.

In one embodiment, the portion of the deposition system deposited with the group III element is a susceptor of the deposition system.

This brief summary has been provided so that the nature of the disclosure may be understood quickly. A more complete understanding of the disclosure can be obtained by reference to the following detailed description of the various embodiments thereof concerning the attached drawings.

### BRIEF DESCRIPTION OF THE DRAWINGS

The foregoing features and other features of the present disclosure will now be described with reference to the drawings of the various embodiments. In the drawings, the same components have the same reference numerals. The illustrated embodiments are intended to illustrate, but not to limit the disclosure. The drawings include the following Figures:

FIG. 1 is an exemplary CVD deposition system that may be cleaned using the exemplary methods of this disclosure;

FIG. 2A shows an exemplary reaction that takes place in the exemplary deposition system of FIG. 1;

FIG. 2B shows an exemplary showerhead of deposition system of FIG. 1, that is deposited with Group III elements or compounds of Group III elements;

FIG. 2C shows an exemplary susceptor of deposition system of FIG. 1, that is deposited with Group III elements or compounds of Group III elements;

FIG. 3 shows flow diagram of an exemplary process of cleaning the deposition system of FIG. 1;

FIG. 4 shows pressure-temperature graph for galliumtrichloride; and

FIG. 5A shows the showerhead of FIG. 2B after subjected to the exemplary process of FIG. 3.

FIG. 5B shows the susceptor of FIG. 2C after subjected to the exemplary process of FIG. 3.

### DETAILED DESCRIPTION

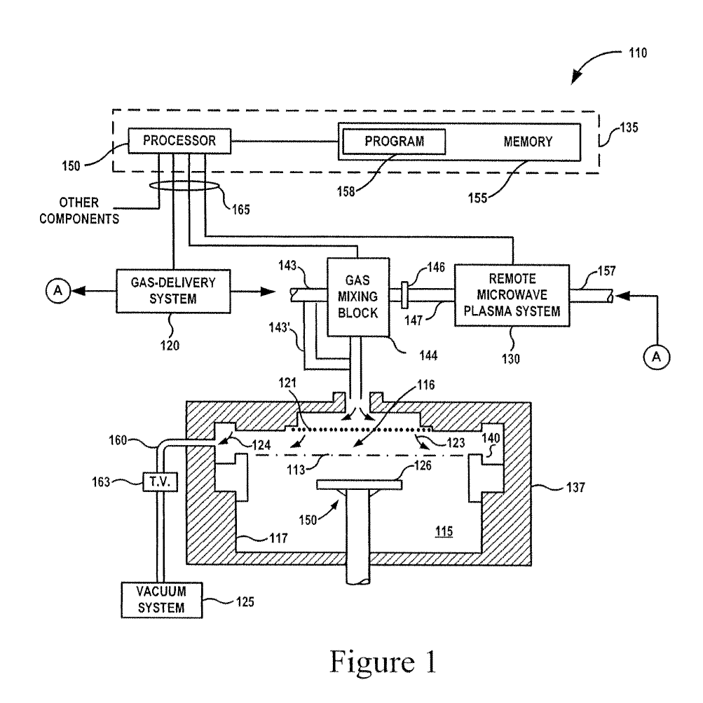

FIG. 1 is a simplified diagram of an exemplary chemical vapor deposition (“CVD”) system 110, illustrating the basic structure of a chamber in which individual deposition steps can be performed. The major components of the system include, among others, a vacuum chamber 115 that receives process and other gases from a gas delivery system 120, a vacuum system 125, a remote plasma system 130, and a control system 135. These and other components are described in more detail below.

While the drawing shows the structure of only a single chamber for purposes of illustration, it will be appreciated that multiple chambers with similar structures may be provided as part of a cluster tool, each tailored to perform different aspects of the overall fabrication process. Other components shown in the drawing supporting the chamber processing may be shared among the multiple chambers, although in some instances individual supporting components may be provided for each chamber separately.

CVD deposition system 110 includes an enclosure assembly 137 that forms vacuum chamber 115 with a gas reaction area 116. A showerhead 121 disperses reactive gases and other gases, such as purge gases, through perforated holes toward a wafer (not shown) that rests on a vertically movable susceptor 126, which also acts as a wafer support pedestal to receive a wafer (not shown). Between showerhead 121 and the wafer is gas reaction area 116. Susceptor 126 can be controllably moved between a lower position, where a wafer can be loaded or unloaded, for example, and a processing position closely adjacent to the showerhead 121, indicated by a dashed line 113, or to other positions for other purposes, such as for an etch or cleaning process.

A center board (not shown) includes sensors for providing information on the position of the wafer. Different structures may be used for susceptor 126 in different embodiments. For instance, in one embodiment, the susceptor 126 includes an electrically resistive heating element (not shown) enclosed in a ceramic. The ceramic protects the heating element from potentially corrosive chamber environments and allows the susceptor attain temperatures up to about 1200 degree Centigrade.

In an exemplary embodiment, all surfaces of susceptor 126 exposed to vacuum chamber 115 are made of a ceramic material, such as aluminum oxide (Al2O3 or alumina) or aluminum nitride. In another embodiment, the susceptor 126 may include a lamp heater. Alternatively, a bare metal filament heating element, constructed of a refractory metal such as tungsten, rhenium, iridium, thorium, or their alloys, may be used to heat the wafer. Such lamp heater arrangements are able to achieve temperatures greater than 1200 degree Centigrade, which may be useful for certain specific applications.

Reactive and carrier gases are supplied from gas delivery system 120 through supply lines 143 into a gas mixing block 144, where they are mixed together and delivered to showerhead 121. Gas delivery system 120 includes a variety of gas sources and appropriate supply lines to deliver a selected amount of each source to chamber 115 as would be understood by a person of skill in the art. Generally, supply lines for each of the gases include shut-off valves that can be used to automatically or manually shut-off the flow of the gas into its associated line, and mass flow controllers or other types of controllers that measure the flow of gas or liquid through the supply lines.

Depending on the process run by deposition system 110, some of the sources may actually be liquid sources rather than gases. When liquid sources are used, gas delivery system includes a liquid injection system or other appropriate mechanism (e.g., a bubbler) to vaporize the liquid. Vapor from the liquids is then usually mixed with a carrier gas as would be understood by a person of skill in the art.

Gas mixing block 144 is a dual input mixing block coupled to process gas supply lines 143 and to a cleaning/etch gas conduit 147. A valve 146 operates to admit or seal gas or plasma from gas conduit 147 to gas mixing block 144. Gas conduit 147 receives gases from an integral remote microwave plasma system 130, which has an inlet 157 for receiving input gases. During deposition processing, gas supplied to the showerhead 121 is vented toward the wafer surface (as indicated by arrows 123), where it may be uniformly distributed radially across the wafer surface in a laminar flow.

In some embodiments, the showerhead 121 may include a plurality of channels (not shown) to receive various gases. Instead of or in addition to the gas mixing block, separate gas lines 143′ may be connected to the plurality of channels so that individual gases are delivered into the vacuum chamber, through the showerhead. For example, by introducing gases through separate channels, the gases interact with each other after exiting the showerhead, and closer to the reaction area.

Purging gas may be delivered into the vacuum chamber 115 from showerhead 121 and/or from inlet ports or tubes (not shown) through the bottom wall of enclosure assembly 137. Purge gas introduced from the bottom of chamber 115 flows upward from the inlet port past the susceptor 126 and to an annular pumping channel 140. Vacuum system 125 which includes a vacuum pump (not shown), exhausts the gas (as indicated by arrows 124) through an exhaust line 160. The rate at which exhaust gases and entrained particles are drawn from the annular pumping channel 140 through the exhaust line 160 is controlled by a throttle valve system 163.

Remote microwave plasma system 130 can produce a plasma for selected applications, such as chamber cleaning or etching residue from a process wafer. Plasma species produced in the remote plasma system 130 from precursors supplied via the input line 157 are sent via the conduit 147 for dispersion through showerhead 120 to vacuum chamber 115. Remote microwave plasma system 130 is integrally located and mounted below chamber 115 with conduit 147 coming up alongside the chamber to gate valve 146 and gas mixing box 144, which is located above chamber 115. Precursor gases for a cleaning application may include fluorine, chlorine and/or other reactive elements. Remote microwave plasma system 130 may also be adapted to deposit CVD layers flowing appropriate deposition precursor gases into remote microwave plasma system 130 during a layer deposition process.

The temperature of the walls of deposition chamber 115 and surrounding structures, such as the exhaust passageway, may be further controlled by circulating a heat-exchange liquid through channels (not shown) in the walls of the chamber. The heat-exchange liquid can be used to heat or cool the chamber walls depending on the desired effect. For example, hot liquid may help maintain an even thermal gradient during a thermal deposition process, whereas a cool liquid may be used to remove heat from the system during an in situ plasma process, or to limit formation of deposition products on the walls of the chamber. Showerhead 121 may also have heat exchanging passages (not shown).

Typical heat-exchange fluids are water-based ethylene glycol mixtures, oil-based thermal transfer fluids, or similar fluids. This heating, referred to as heating by the “heat exchanger”, beneficially reduces or eliminates condensation of undesirable reactant products and improves the elimination of volatile products of the process gases and other contaminants that might contaminate the process if they were to condense on the walls of cool vacuum passages and migrate back into the processing chamber during periods of no gas flow.

System controller 135 controls activities and operating parameters of the deposition system 110. System controller 135 includes a computer processor 150 and a computer-readable memory 155 coupled to processor 150. Processor 150 executes system control software, such as computer program 158 stored in memory 170. Memory 170 is preferably a hard disk drive but may be other kinds of memory, such as read-only memory or flash memory. System controller 135 also includes a floppy disk drive, CD, or DVD drive (not shown).

Processor 150 operates according to system control software (program 158), which includes computer instructions that dictate the timing, mixture of gases, chamber pressure, chamber temperature, microwave power levels, pedestal position, and other parameters of a particular process. Control of these and other parameters is effected over control lines 165, only some of which are shown in FIG. 1A, that communicatively couple system controller 135 to the susceptor, throttle valve, remote plasma system and the various valves and mass flow controllers associated with gas delivery system 120.

Processor 150 has a card rack (not shown) that contains computer boards, analog and digital input/output boards, interface boards and stepper motor controller boards. Various parts of the CVD system 110 conform to the Versa Modular European (VME) standard which defines board, card cage, and connector dimensions and types. The VME standard also defines the bus structure having a 16-bit data bus and 24-bit address bus.

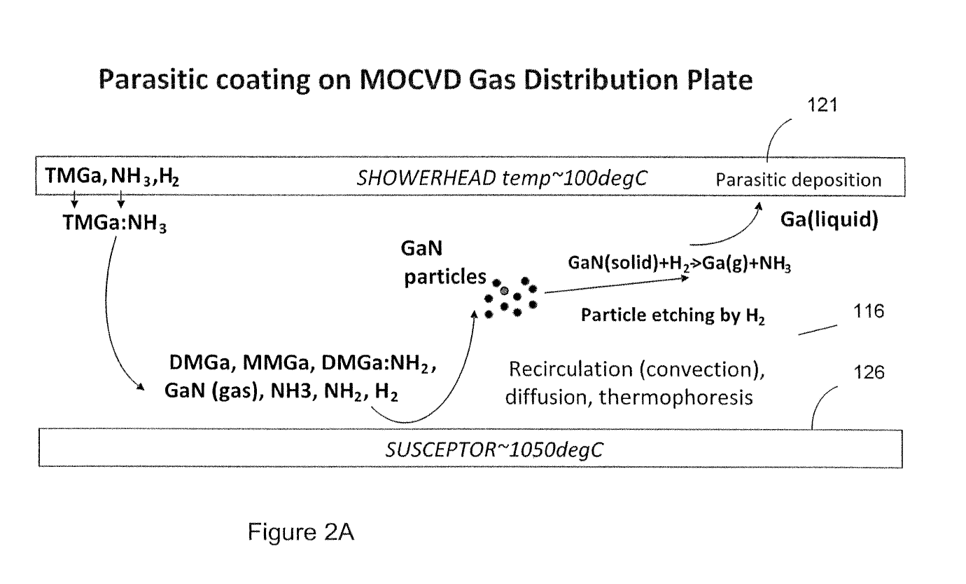

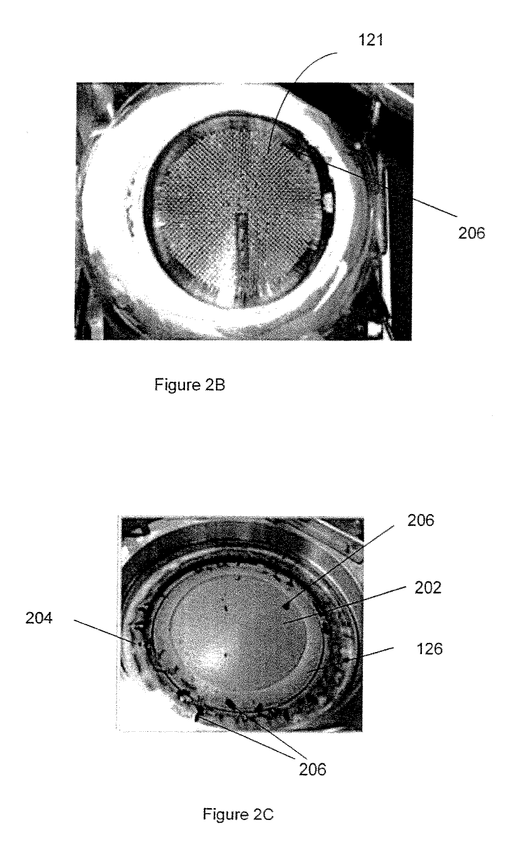

FIG. 2A shows an exemplary reaction that takes place in the CVD deposition system 110 about the gas reaction area 116, between the susceptor 126 and the showerhead 121, during the deposition of gallium nitride on to a wafer (not shown) disposed over the susceptor 126. In the exemplary deposition system 110, the temperature of the showerhead 121 is maintained around about 100 degree centigrade and the susceptor 126 is maintained at about 1050 degree centigrade. Trimethylgallium, ammonia and hydrogen gas are introduced through the showerhead 121. Trimethylgallium reacts with ammonia and hydrogen in the reaction area 116.

As shown in FIG. 2A, based upon the reaction, various elements and compounds are formed, including for example, Dimethylgallium (DMGa), Monomethylgallium (MMGa), and Ga. Gallium Nitride is formed by reaction of Ga (TMGa, DMGa, MMGa) with ammonia, NH2, NH, etc. Further, in some embodiments, gallium nitride particles may also get deposited on the surface of the showerhead 121.

FIG. 2B shows an exemplary showerhead 121 with deposits 206 of gallium and gallium nitride deposited over the showerhead, based upon the phenomenon described with reference to FIG. 2. More specifically, the gallium droplets are deposited about the periphery of the showerhead 121. The deposition of gallium on the showerhead 121 will impact the thin film grown in the deposition chamber. For example, the deposits 206 of gallium may cause stray particles and flakes of gallium to be released in the reaction chamber during a deposition cycle. Release of stray particles and flakes of gallium may affect the quality of the thin film being grown inside the reaction chamber.

FIG. 2C shows an exemplary susceptor 126 with carrier 202 disposed in the middle and a liner 204 surrounding the susceptor 126. The carrier 202 is configured to receive a wafer (not shown). As it can be seen, deposits 206 of gallium and gallium nitride are disposed over portions of the susceptor 126, carrier 202 and liner 204, based upon the phenomenon described with reference to FIG. 2A. These deposits 206 are not desirable, as release of stray particles and flakes of gallium may affect the quality of the thin film being grown inside the reaction chamber.

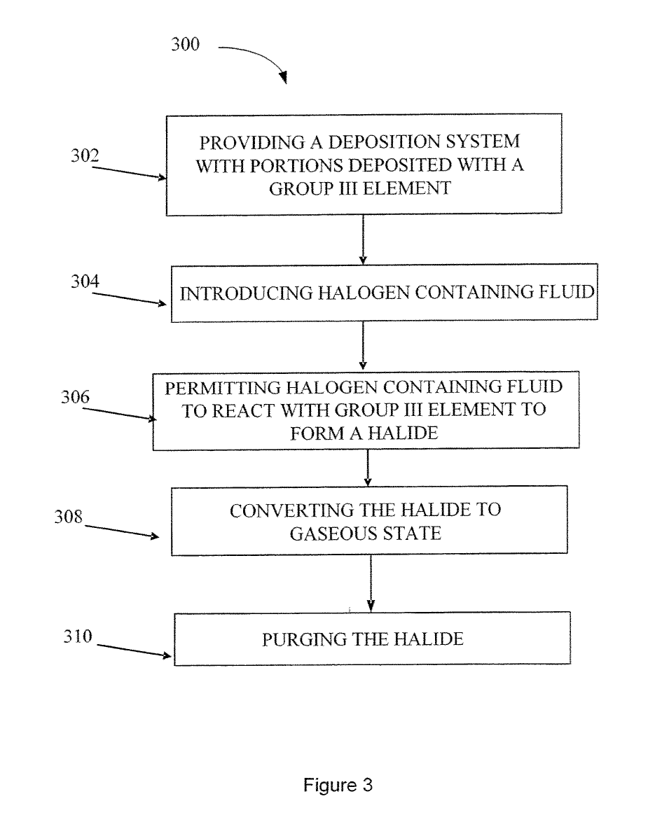

FIG. 3 shows an exemplary process 300 to clean the deposits of gallium and/or gallium-rich gallium nitride inside the deposition system, for example, deposits over the showerhead 121, susceptor 126, carrier 202 and liner 204. In one embodiment, the cleaning process is performed in-situ, that is, without removing the parts of the deposition system. For example, without removing the showerhead 121, susceptor 126, carrier 202 and the liner 204 from the deposition system.

In step 302, a deposition system with portions of the deposition system deposited with a group III element or a group III compound is provided. In one embodiment, the group III element may be gallium and Group III compound may be gallium nitride. In one embodiment, portion of the showerhead 121 is deposited with gallium and/or gallium nitride. In some embodiments, the susceptor 126 is deposited with gallium and/or gallium nitride. In some embodiments, the carrier 202 is deposited with gallium and/or gallium nitride. In some embodiments, the liner 204 is deposited with gallium and/or gallium nitride.

In some embodiments, step 302 further includes pre-purging of the deposition system. During the pre-purging of the deposition system, a purge gas, for example, nitrogen is introduced into the deposition system. For example, the purge gas may be flown through the showerhead. For example, purge gas nitrogen may be introduced into the deposition chamber at a flow rate of about 1 slm to about 15 slm and preferably at about 10 slm. In one embodiment, purge gas may be introduced for about 2 minutes to about 10 minutes, preferably for about 5 minutes.

In some embodiments, pre-purging of the deposition system may be repeated from about two times to about ten times, preferably about three times. In some embodiments, the pre-purging of the deposition system assists in purging any traces of gases introduced into the deposition system during the deposition process steps. For example, the pre-purging of the deposition system may assist in purging any remaining trimethylgallium and ammonia from the deposition system.

In step 304, a halogen containing fluid is introduced into the deposition system. In one embodiment, a chlorine containing fluid is introduced into the deposition chamber. In one embodiment, nitrogen gas is used as a precursor gas to deliver chlorine. In one embodiment, the halogen containing fluid is introduced into the deposition chamber at a flow rate of about 1 slm to about 10 slm and preferably at about 4 slm. The precursor gas may be introduced into the deposition chamber at a flow rate of about 1 slm to about 15 slm and preferably at about 1 slm.

In step 306, the halogen containing fluid is permitted to react with the group III element and/or group III compound to form a halide. In one embodiment, chlorine containing fluid is permitted to react with gallium to form galliumtrichloride. In one embodiment, the chamber pressure is increased to enhance chlorination process and yet maintain the pressure preferably at a level lower than that required to initiate condensation. This facilitates the formation of galliumtrichloride primarily in gaseous state, yet some amount of galliumtrichloride will be formed in solid state. The reaction is permitted to occur for sufficient time so as to convert liquid gallium and gallium nitride to galliumtrichloride. In one embodiment, the pressure inside the chamber was maintained between 80 Torr to 600 Torr and preferably at about 100 Torr. The temperature of the showerhead was maintained between about 80 degree centigrade to about 180 degree centigrade and preferably about 100 degree centigrade. In one embodiment, the pressure is maintained high enough that gallium and gallium nitride are converted to galliumtrichloride. In one embodiment, it is preferable that most of the galliumtrichloride that is formed is in gaseous state. However, some condensation of the galliumtrichloride will occur, thus forming some amount of galliumtrichloride in solid state. In one embodiment, the high pressure is maintained between 2 minutes to about 5 minutes and preferably, for about 3 minutes.

In step 308, the halide is converted from a solid state to a gaseous state. In one embodiment, the galliumtrichloride is converted from a solid state to a gaseous state. The pressure inside the deposition system is lowered so as to bring the pressure inside the chamber to be below the pressure at which the halide converts from a solid phase to a gaseous phase. For example, the pressure inside the deposition system is reduced so as to convert residual galliumtrichloride from a solid phase to a gaseous phase.

In one embodiment, the pressure inside the chamber may be reduced to about 10 mTorr to about 8 Torr and preferably about 2 Torr. The temperature of the showerhead is maintained between about 80 degree centigrade to about 130 degree centigrade and preferably at about 100 degree centigrade. The temperature of the susceptor is maintained between about 500 degree centigrade to about 700 degree centigrade and preferably at about 650 degree centigrade. In one embodiment, the low pressure is maintained between 2 minutes to about 10 minutes and preferably, for about 5 minutes.

In step 310, the converted gaseous halide is purged out of the deposition chamber. In one example, the galliumtrichloride is purged out of the deposition chamber. In order to assist in the purging of the gaseous halide from the deposition chamber, purge gas, for example, inert gas may be flown into the deposition system. For example, the purge gas may be flown through the showerhead. For example, purge gas nitrogen may be introduced into the deposition chamber at a flow rate of about 1 slm to about 15 slm and preferably at about 10 slm. In one embodiment, purge gas may be introduced for about 2 minutes to about 10 minutes, preferably for about 5 minutes.

In some embodiments, the steps 304 through 310 may be repeated multiple times so as to increase the efficiency of cleaning the inside of the deposition system and more particularly, the showerhead and/or the susceptor of the deposition system. In some embodiments, steps 304 through 310 may be repeated from about two times to about 10 times, preferably about seven times.

Although exemplary embodiments have been described with reference to gallium, as one skilled in the art appreciates, the exemplary processes can be used for indium and aluminum based deposits as well when InCl3 and AlCl3 will form. But amount of those deposition may be minimal since Ga is predominant component in Ga—In—Al—N system. Further, other halides like fluorine, bromine and iodine may be suitably used instead of chlorine.

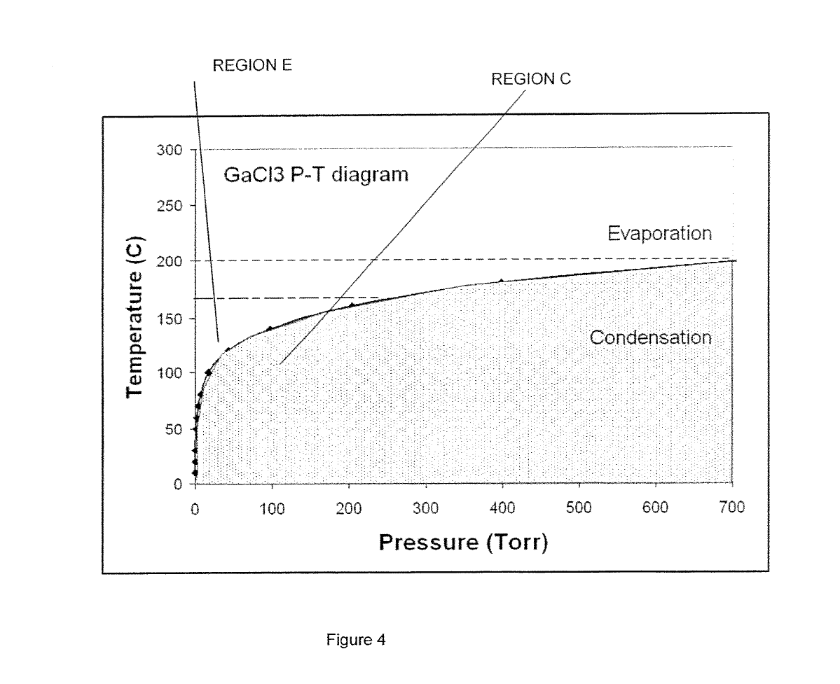

FIG. 4 shows the pressure-temperature (P-T) diagram for galliumtrichloride. As it is evident from the P-T graph, if the temperature is maintained below certain level and the pressure is maintained high, condensation of the galliumtrichloride is facilitated, as shown by the shaded region C.

Further, if the pressure is reduced and the temperature is raised above a certain level, evaporation of the galliumtrichloride is facilitated, as shown by the region E. So, the temperature and pressure inside the deposition chamber is maintained such that gallium reacts with chlorine and forms galliumtrichloride solid on the showerhead. After converting gallium to galliumtrichloride, the pressure is reduced to facilitate the evaporation of galliumtrichloride. The temperature may be raised appropriately to provide an environment conducive to the evaporation of the galiiumtrichloride.

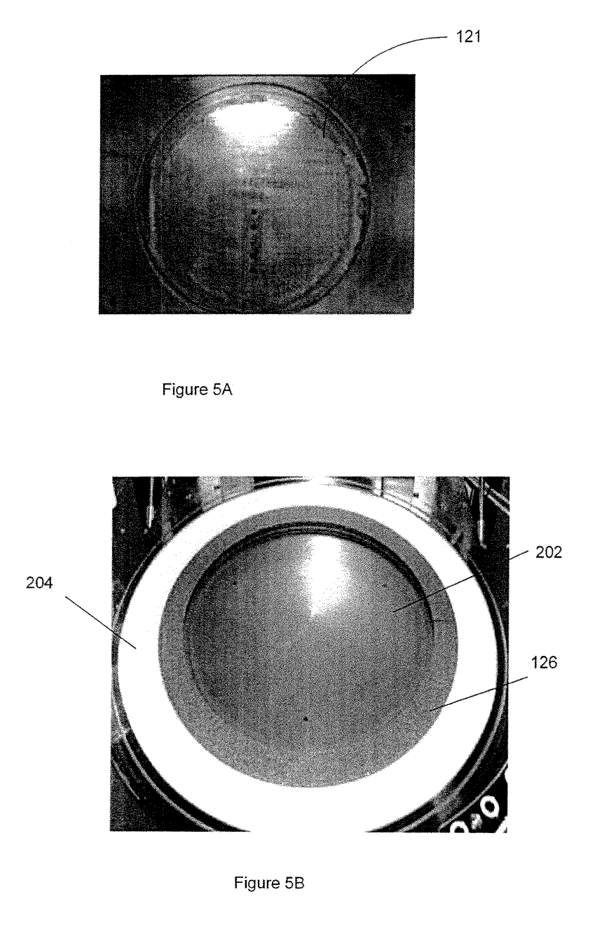

FIG. 5A shows the showerhead 121 of FIG. 2B that has been cleaned using the exemplary process described herein. As it is evident from FIG. 5A, the showerhead 121 has no apparent deposits of gallium or gallium nitride on the surface of the showerhead 121.

FIG. 5B shows the susceptor 126 with carrier 202 and liner 204 of FIG. 2C that has been cleaned using the exemplary process described herein. As it is evident from FIG. 5B, the susceptor 126, carrier 202 and liner 204 have no apparent deposits of gallium or gallium nitride on their surfaces.

Although the present disclosure has been described with reference to specific embodiments, these embodiments are illustrative only and not limiting. Many other applications and embodiments of the present disclosure will be apparent in light of this disclosure.

What is claimed is:

1. A method for in-situ cleaning of a deposition system, comprising:
providing a deposition system with portions of the deposition system deposited with at least a group III element or a compound of a group III element;
introducing halogen containing fluid into the deposition system;
permitting the halogen containing fluid to react with the group III element or the compound of the group III element to form a halide;
converting the halide to a gaseous state; and
purging the halide in gaseous state out of the deposition system.

2. The method of claim 1, wherein the portion of the deposition system deposited with at least the group III element or the compound of the group III element is a showerhead of the deposition system.

3. The method of claim 1, wherein the halogen containing fluid includes nitrogen as a precursor gas.

4. The method of claim 1, wherein the step of permitting further including increasing the pressure within the deposition system.

5. The method of claim 4, wherein the pressure is maintained between about 80 Torr to about 600 Torr.

6. The method of claim 4, wherein the pressure is maintained between about 80 Torr to about 100 Torr.

7. The method of claim 1, wherein the step of converting further including reducing the pressure within the deposition system.

8. The method of claim 7, wherein the pressure is maintained between about 10 mTorr to about 8 torr.

9. The method of claim 7, wherein the pressure is maintained between about 2 Torr to about 8 Torr.

10. The method of claim 1, wherein the halogen containing fluid includes chlorine.

11. The method of claim 1, wherein the halogen containing fluid includes fluorine.

12. The method of claim 1, wherein the halogen containing fluid includes bromine.

13. The method of claim 1, wherein the portion of the deposition system deposited with at least the group III element or the compound of the group III element is a susceptor of the deposition system.

14. The method of claim 1, wherein the portion of the deposition system deposited with at least the group III element or the compound of the group III element is a carrier of the deposition system.

15. The method of claim 1, wherein the portion of the deposition system deposited with at least the group III element or the compound of the group III element is a liner of the deposition system.

16. The method of claim 1, wherein providing a deposition system includes pre-purging the deposition system with purge gas.

17. The method of claim 16, wherein the purge gas is nitrogen.
